(19) United States
(12) Patent Application Publication
(10) Pub. No.: US 2007/0245710 A1
(43) Pub. Date: Oct. 25, 2007

(54) Optimized configuration of a reverse flow combustion system for a gas turbine engine

(75) Inventors: Jurgen C. Schumacher, Phoenix, AZ (US); Rodolphe Dudebout, Phoenix, AZ (US); Brad R. Bazzell, Scottsdale, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/408,662

(22) Filed: Apr. 21, 2006

(51) Int. Cl. F02K 3/04

(52) U.S. Cl. 60/226.1; 60/740

(57) ABSTRACT

An apparatus is provided for a gas turbine engine. The gas turbine engine comprises a high pressure compressor, a single-stage high pressure turbine, a multi-stage low pressure turbine, and a reverse flow combustor unit. The reverse flow combustor comprises a combustor liner assembly, a combustor dome, and a plurality of straight-shafted fuel injectors. The combustor liner assembly includes an inner liner and an outer liner. The inner liner surrounds the single-stage high pressure turbine, and the outer liner is disposed radially outwardly of, and at least partially surrounding, the inner liner. The combustor dome assembly is coupled between the inner liner and the outer liner to define a combustion chamber therebetween. The plurality of straight-shafted fuel injectors are coupled to the combustor dome, with each fuel injector having at least an inlet, an outlet, and a linear fuel passageway extending therebetween.

### TECHNICAL FIELD

The present invention generally relates to a reverse flow combustion system for a gas turbine engine, and more particularly relates to a gas turbine engine having an optimized reverse flow combustion system configuration.

### BACKGROUND

A gas turbine engine may be used to power various types of vehicles and systems. A particular type of gas turbine engine that may be used to power aircraft is a turbofan gas turbine engine. A turbofan gas turbine engine may include, for example, five major sections, a fan section, a compressor section, a combustor section, a turbine section, and an exhaust section. The fan section is positioned at the front, or “inlet” section of the engine, and includes a fan that induces air from the surrounding environment into the engine, and accelerates a fraction of this air toward the compressor section. The remaining fraction of air induced into the fan section is accelerated into and through a bypass plenum, and out the exhaust section.

The compressor section raises the pressure of the air it receives from the fan section to a relatively high level. In a multi-spool engine, the compressor section may include two or more compressors. The compressed air from the compressor section then enters the combustor section, where a ring of fuel nozzles injects a steady stream of fuel. The injected fuel is ignited by a burner, which significantly increases the energy of the compressed air.

The high-energy compressed air from the combustor section then flows into and through the turbine section, causing rotationally mounted turbine blades to rotate and generate energy. The air exiting the turbine section is exhausted from the engine via the exhaust section, and the energy remaining in this exhaust air aids the thrust generated by the air flowing through the bypass plenum.

As performance demands have increased, the turbine sections of many new turbofan engines have increased in size in order to meet the increased performance requirements. Often this results in a configuration in which the turbofan engine has a single-stage high pressure turbine, as well as a multi-stage low pressure turbine disposed downstream therefrom. However, this type of configuration typically results in the use of bent, rather than straight, fuel injectors. Although this configuration is generally reliable, bent fuel injectors can be relatively more costly and difficult to produce than straight-shafted fuel injectors. Accordingly, there is a need for a turbofan engine, having a single-stage high pressure turbine and a multi-stage low pressure turbine that includes straight-shafted fuel injectors.

### BRIEF SUMMARY OF THE INVENTION

An apparatus is provided for a gas turbine engine. In one embodiment, and by way of example only, the gas turbine engine comprises a high pressure compressor, a single-stage high pressure turbine, a multi-stage low pressure turbine, and a reverse flow combustor unit. The high pressure compressor is coupled to receive a first drive force and is operable, upon receipt of the drive force, to supply a flow of compressed air. The single-stage high pressure turbine is coupled to receive combustion gases and is operable, upon receipt thereof, to supply the first drive force to the high pressure compressor and to supply a flow of high pressure turbine gas exhaust. The multi-stage low pressure turbine is coupled to receive the high pressure turbine gas exhaust from the single-stage high pressure turbine and is operable, upon receipt thereof, to supply a second drive force. The reverse flow combustor, which is disposed radially outwardly of the single-stage high pressure turbine and axially upstream of the multi-stage low pressure turbine, comprises a combustor liner assembly, a combustor dome, and a plurality of straight-shafted fuel injectors. The combustor liner assembly includes an inner liner and an outer liner. The inner liner surrounds the single-stage high pressure turbine. The outer liner is disposed radially outwardly of, and at least partially surrounding, the inner liner. The combustor dome assembly is coupled between the inner liner and the outer liner to define a combustion chamber therebetween. The combustion chamber is fluidly coupled to receive the flow of compressed air supplied from the high pressure compressor. The plurality of straight-shafted fuel injectors are coupled to the combustor dome. Each fuel injector has at least an inlet, an outlet, and a linear fuel passageway extending therebetween. The fuel injector inlet is adapted to receive a flow of fuel. The fuel injector outlet is fluidly coupled to the combustion chamber.

In another embodiment, and by way of example only, the gas turbine engine comprises a high pressure compressor, a single-stage high pressure turbine, a multi-stage low pressure turbine, and a reverse flow combustor unit. The high pressure compressor is coupled to receive a first drive force and is operable, upon receipt of the drive force, to supply a flow of compressed air. The single-stage high pressure turbine is coupled to receive combustion gases and is operable, upon receipt thereof, to supply the first drive force to the high pressure compressor and to supply a flow of high pressure turbine gas exhaust. The single-stage high pressure turbine is configured to rotate about a rotational axis. The multi-stage low pressure turbine is coupled to receive the high pressure turbine gas exhaust from the single-stage high pressure turbine and is operable, upon receipt thereof, to supply a second drive force. The reverse flow combustor, which is disposed radially outwardly of the single-stage high pressure turbine and axially upstream of the multi-stage low pressure turbine, comprises a combustor liner assembly, a combustor dome, and a plurality of straight-shafted fuel injectors. The combustor liner assembly includes an inner liner and an outer liner. The inner liner surrounds the single-stage high pressure turbine. The outer liner is disposed radially outwardly of, and at least partially surrounding, the inner liner. The combustor dome assembly is coupled between the inner liner and the outer liner to define a combustion chamber therebetween. The combustion chamber is fluidly coupled to receive the flow of compressed air supplied from the high pressure compressor. The plurality of straight-shafted fuel injectors are coupled to the combustor dome. Each fuel injector has at least an inlet, an outlet, and a linear fuel passageway extending therebetween. The fuel injector inlet is adapted to receive a flow of fuel. The fuel injector outlet is fluidly coupled to the combustion chamber. At least one of the straight-shafted fuel injectors has an axis of symmetry, and the straight fuel injector axis of symmetry is not parallel to the single-stage high pressure turbine rotational axis.

### BRIEF DESCRIPTION OF THE DRAWINGS

The present invention will hereinafter be described in conjunction with the following drawing figures, wherein like numerals denote like elements, and

FIG. 1 depicts a simplified cross section side view of an exemplary multi-spool turbofan gas turbine jet engine; and

FIG. 2 depicts a cross section view of an embodiment of a combustor unit that may be used in an engine such as the engine of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

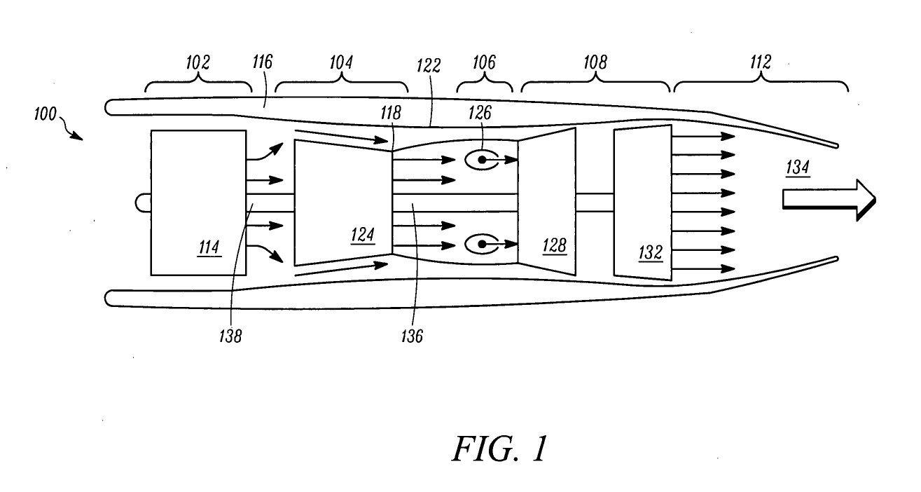

FIG. 1 depicts an embodiment of an exemplary multi-spool gas turbine main propulsion engine 100. The engine 100 includes an intake section 102, a compressor section 104, a combustion section 106, a turbine section 108, and an exhaust section 112. The intake section 102 includes a fan 114, which is mounted in a fan case 116. The fan 114 draws air into the intake section 102 and accelerates it. A fraction of the accelerated air exhausted from the fan 114 is directed through a bypass section 118 disposed between an engine cowl 122 and a compressor 124, and generates propulsion thrust. The remaining fraction of air exhausted from the fan 114 is directed into the compressor section 104.

The compressor section 104 may include one or more compressors 124, which raise the pressure of the air directed into it from the fan 114, and directs the compressed air into the combustion section 106. In the depicted embodiment, only a single compressor 124 is shown, though it will be appreciated that one or more additional compressors could be used. In the combustion section 106, which includes a combustor unit 126, the compressed air is mixed with fuel supplied from a fuel source (not shown). The fuel/air mixture is combusted, generating high energy combusted gas that is then directed into the turbine section 108. The combustor unit 126 may be implemented as any one of numerous types of combustor units. However, as will be discussed in more detail further below, the combustor unit 126 is preferably implemented as a reverse flow combustor unit.

The turbine section 108 includes one or more turbines. In the depicted embodiment, the turbine section 108 includes two turbines, a high pressure turbine 128, and a low pressure turbine 132, and more particularly, a single-stage high pressure turbine 128 and a multi-stage low pressure turbine 132. However, it will be appreciated that the propulsion engine 100 could be configured with more than this number of turbines. No matter the particular number of turbines, the combusted gas from the combustion section 106 expands through each turbine 128, 132, causing it to rotate. The gas is then exhausted through a propulsion nozzle 134 disposed in the exhaust section 112, generating additional propulsion thrust. As the turbines 128, 132 rotate, each drives equipment in the main propulsion engine 100 via concentrically disposed shafts or spools. Specifically, the high pressure turbine 128 drives the compressor 124 via a high pressure spool 136, and the low pressure turbine 132 drives the fan 114 via a low pressure spool 138.

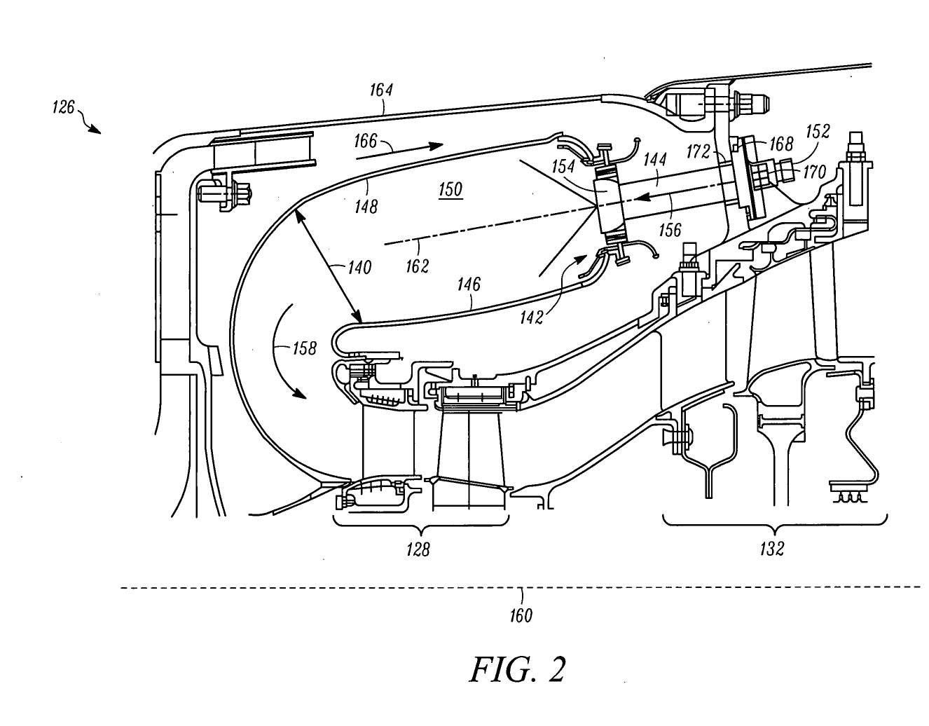

Turning now to FIG. 2, a cross section view of a particular embodiment of the reverse flow combustor unit 126 is depicted and will now be described in more detail. In this embodiment, the combustor unit 126 is disposed radially outwardly of the single-stage high pressure turbine 128, and axially upstream of the multi-stage low pressure turbine 132. The combustor unit 126 preferably includes an annular liner assembly 140, a dome assembly 142, and a plurality of fuel injectors 144.

As shown in FIG. 2, the annular liner assembly 140 includes an inner annular liner 146 and an outer annular liner 148. The inner annular liner 146 surrounds the single-stage high pressure turbine 128. The outer annular liner 148, in turn, is preferably disposed radially outwardly of, and at least partially surrounds, the inner annular liner 146. The inner and outer annular liners 146, 148 have a plurality of non-illustrated openings for the flow of air therethrough.

The combustor dome assembly 142 is coupled between the inner annular liner 146 and the outer annular liner 148 to define a combustion chamber 150. The combustion chamber 150 is fluidly coupled to receive the flow of compressed air supplied from the compressor section 104, and more particularly from the high pressure compressor 124 (not depicted in FIG. 2), and through the above-referenced openings in the inner and outer annular liners 146, 148.

The plurality of straight-shafted fuel injectors 144 (for ease of reference, only one fuel injector 144 is depicted in FIG. 2) are coupled to the combustor dome assembly 142. Preferably each straight fuel injector 144 has at least one fuel inlet 152 that is adapted to receive a flow of fuel, an outlet 154 that is in fluid communication with the combustion chamber 150, and a linear fuel passageway 156 extending therebetween. It will be appreciated by one of skill in the art that, in some embodiments, one or more of the fuel injectors 144 may have different characteristics than other fuel injectors 144. For example, one or more of the fuel injectors 144 may not have a linear fuel passageway 156.

Regardless of whether each of the fuel injectors 144 are identical, a mixture of fuel and air is supplied to the combustion chamber 150 via the fuel injector outlet 154, and is then ignited within the combustor chamber 150 by one or more igniters (not shown), generating combustion gas. The combustion gas then flows through a transition liner passageway 158, which directs it into the single-stage high pressure turbine 128. The gas exhausted from the single-stage high pressure turbine 128 is then directed into the multi-stage low pressure turbine 132.

In a preferred embodiment, the single-stage high pressure turbine 128 is configured, upon receipt of the combustion gas, to rotate about a rotational axis 160. In addition, at least one, and preferably each of, the straight-shafted fuel injectors 144, when installed, have an axis of symmetry 162 that is not parallel to the rotational axis 160. As a result, the combustor dome assembly 142 has a substantially conical shape, about axis 160. This substantial conical shape in turn provides enhanced stiffness and structural integrity for the combustor dome assembly 142, which facilitates the use of the straight-shafted fuel injectors 144. The straight-shafted fuel injectors 144 are advantageous, for example in that they are easier and less expensive to manufacture, compared with their bent counterparts typically used in this type of combustor unit 126.

The combustor unit 126 is preferably mounted within a combustor casing 164. Preferably, the combustor casing 164 is disposed radially outwardly of, and at least partially surrounds, the outer annular liner 148. Together, the combustor casing 164 and the outer annular liner 148 at least partially define a compressed air passageway 166 for the flow of compressed air from the high pressure compressor 124 to the combustor unit 126. In this embodiment, the straight-shafted fuel injectors 144 are preferably coupled to the combustor casing 164, as well as to the combustor dome assembly 142. To do so, the combustor unit 126 may also include one or more flanges 168, such as bayonet flanges, or any one of numerous other types of flanges, for securing the straight-shafted fuel injectors 144 to the combustor unit 126 via, for example, a plurality of bolts 170. It will be appreciated that this is merely exemplary, and that in other embodiments, mating threads 172 may be disposed on at least a portion of the combustor unit 126, for example on the combustor casing 164, and on the straight-shafted fuel injectors 144 to secure the straight-shafted fuel injectors 144 to the dome assembly 142. It will be appreciated that the straight-shafted fuel injectors 144 can also be secured to the combustor unit 126 at various other regions on the combustor unit 126, and that any one of numerous mechanisms can be used for securing the straight-shafted fuel injectors 144 to the combustor unit 126.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A turbofan gas turbine engine, comprising:
a high pressure compressor coupled to receive a first drive force and operable, upon receipt of the drive force, to supply a flow of compressed air;
a single-stage high pressure turbine coupled to receive combustion gases and operable, upon receipt thereof, to (i) supply the first drive force to the high pressure compressor and (ii) supply a flow of high pressure turbine gas exhaust;
a multi-stage low pressure turbine coupled to receive the high pressure turbine gas exhaust from the single-stage high pressure turbine and operable, upon receipt thereof, to supply a second drive force; and
an annular reverse flow combustor unit disposed radially outwardly of the single-stage high pressure turbine and axially upstream of the multi-stage low pressure turbine, the reverse flow combustor unit comprising:
a combustor liner assembly including an inner liner and an outer liner, the inner liner surrounding the single-stage high pressure turbine, the outer liner disposed radially outwardly of, and at least partially surrounding, the inner liner;
a combustor dome assembly coupled between the inner liner and the outer liner to define a combustion chamber therebetween, the combustion chamber fluidly coupled to receive the flow of compressed air supplied from the high pressure compressor; and
a plurality of straight-shafted fuel injectors coupled to the combustor dome, each fuel injector having at least an inlet, an outlet, and a linear fuel passageway extending therebetween, the fuel injector inlet adapted to receive a flow of fuel, the fuel injector outlet fluidly coupled to the combustion chamber.

2. The turbofan engine of claim 1, wherein:
the single-stage high pressure turbine is configured to rotate about a rotational axis;
the straight-shafted fuel injectors have an axis of symmetry; and
the straight fuel injector axis of symmetry is not parallel to the single-stage high pressure turbine rotational axis.

3. The turbofan engine of claim 1, further comprising:
a plurality of threads disposed on the combustor unit; and
mating threads disposed on the straight-shafted fuel injectors to secure the straight-shafted fuel injectors to the combustor unit via the combustor unit threads.

4. The turbofan engine of claim 1, wherein the combustor dome assembly is substantially conically shaped.

5. The turbofan engine of claim 1, further comprising:
a combustor casing disposed radially outwardly of, and at least partially surrounding, the outer liner of the combustor liner assembly.

6. The turbofan engine of claim 5, wherein the combustor casing and the outer liner of the combustor liner assembly define a passageway for the flow of compressed air from the high pressure compressor to the combustion chamber.

7. The turbofan engine of claim 5, wherein the straight-shafted fuel injectors are coupled to the combustor casing.

8. The turbofan engine of claim 1, further comprising:
one or more flanges configured to secure the straight-shafted fuel injectors to the combustor unit.

9. The turbofan engine of claim 8, wherein the flanges are configured to secure the straight-shafted fuel injectors to the combustor unit through a plurality of bolts.

10. The turbofan engine of claim 8, wherein the flanges are bayonet flanges.

11. A turbofan gas turbine engine, comprising:
a high pressure compressor coupled to receive a first drive force and operable, upon receipt of the drive force, to supply a flow of compressed air;
a single-stage high pressure turbine coupled to receive combustion gases and operable, upon receipt thereof, to (i) supply the first drive force to the high pressure compressor and (ii) supply a flow of high pressure turbine gas exhaust, wherein the single-stage high pressure turbine is configured to rotate about a rotational axis;
a multi-stage low pressure turbine coupled to receive the high pressure turbine gas exhaust from the single-stage high pressure turbine and operable, upon receipt thereof, to supply a second drive force; and
a reverse flow combustor unit disposed radially outwardly of the single-stage high pressure turbine and axially upstream of the multi-stage low pressure turbine, the reverse flow combustor unit comprising:
an annular combustor liner assembly including an inner liner and an outer liner, the inner liner surrounding the single-stage high pressure turbine, the outer liner disposed radially outwardly of, and at least partially surrounding, the inner liner;
a combustor dome assembly coupled between the inner liner and the outer liner to define a combustion chamber therebetween, the combustion chamber fluidly coupled to receive the flow of compressed air supplied from the high pressure compressor; and
a plurality of straight-shafted fuel injectors coupled to the combustor dome, each fuel injector having at least an inlet, an outlet, and a linear fuel passageway extending therebetween, each fuel injector inlet adapted to receive a flow of fuel, each fuel injector outlet fluidly coupled to the combustion chamber, and wherein at least one of the straight-shafted fuel injectors has an axis of symmetry, and the straight fuel injector axis of symmetry is not parallel to the single-stage high pressure turbine rotational axis.

12. The turbofan engine of claim 11, further comprising:
a plurality of threads disposed on the combustor unit; and
mating threads disposed on the straight-shafted fuel injectors to secure the straight-shafted fuel injectors to the combustor unit via the combustor unit threads.

13. The turbofan engine of claim 11, wherein the combustor dome assembly is substantially conically shaped.

14. The turbofan engine of claim 11, further comprising:
a combustor casing disposed radially outwardly of, and at least partially surrounding, the outer liner of the combustor liner assembly.

15. The turbofan engine of claim 14, wherein the combustor casing and the outer liner of the combustor liner assembly at least partially define a passageway for the flow of compressed air from the high pressure compressor to the combustion chamber.

16. The turbofan engine of claim 14, wherein the straight-shafted fuel injectors are coupled to the combustor casing.

17. The turbofan engine of claim 11, further comprising:
one or more flanges configured to secure the straight-shafted fuel injectors to the combustor unit.

18. The turbofan engine of claim 17, wherein the flanges are configured to secure the straight-shafted fuel injectors to the combustor unit through a plurality of bolts.

19. The turbofan engine of claim 17, wherein the flanges are bayonet flanges.

20. A turbofan engine, comprising:
a high pressure compressor coupled to receive a first drive force and operable, upon receipt of the drive force, to supply a flow of compressed air;
a single-stage high pressure turbine coupled to receive combustion gases and operable, upon receipt thereof, to (i) supply the first drive force to the high pressure compressor and (ii) supply a flow of high pressure turbine gas exhaust, wherein the single-stage high pressure turbine is configured to rotate about a rotational axis;
a multi-stage low pressure turbine coupled to receive the high pressure turbine gas exhaust from the single-stage high pressure turbine and operable, upon receipt thereof, to supply a second drive force; and
an annular reverse flow combustor unit disposed radially outwardly of the single-stage high pressure turbine and axially upstream of the multi-stage low pressure turbine, the reverse flow combustor unit comprising:
a combustor liner assembly including an inner liner and an outer liner, the inner liner surrounding the single-stage high pressure turbine, the outer liner disposed radially outwardly of, and at least partially surrounding, the inner liner;
a substantially conically shaped combustor dome assembly coupled between the inner liner and the outer liner to define a combustion chamber therebetween, the combustion chamber fluidly coupled to receive the flow of compressed air supplied from the high pressure compressor;
a combustor casing disposed radially outwardly of, and at least partially surrounding, the outer liner of the combustor liner assembly, at least partially defining a passageway for the flow of compressed air from the high pressure compressor to the combustion chamber; and
a plurality of straight-shafted fuel injectors coupled to the combustor dome and the combustor casing, each fuel injector having at least an inlet, an outlet, and a linear fuel passageway extending therebetween, each fuel injector inlet adapted to receive a flow of fuel, each fuel injector outlet fluidly coupled to the combustion chamber, and wherein at least one of the straight-shafted fuel injectors has an axis of symmetry, and the straight fuel injector axis of symmetry is not parallel to the single-stage high pressure turbine rotational axis.
